(19) United States
(12) Patent Application Publication
(10) Pub. No.: US 2002/0109367 A1
(43) Pub. Date: Aug. 15, 2002

(54) Assembly for truck bed and tailgate extension

(76) Inventor: Paul L. Terrusa, Woodland Hills, CA (US)

Correspondence Address: Marc Steven Colen, 20300 Ventura Blvd., #120, Woodland Hills, CA, 91364, US

(21) Appl. No.: 09/781,736

(22) Filed: Feb. 12, 2001

(51) Int. Cl. B62D 33/08

(52) U.S. Cl. 296/26.08; 296/57.1

(57) ABSTRACT

A truck bed extension assembly mounted only when needed on the truck bed and lowered (e.g., horizontal) tail gate of a material transport vehicle, such as a pickup truck, providing for enhanced material handling capacity, while being able to be stored within the truck bed when not needed. The assembly is generally comprised of two lengthwise members placed within and both temporarily and nominally attached to said truck bed, and extending beyond the truck bed and two vertical members temporarily attached to lengthwise members in order to constrain the load within the truck.

### BACKGROUND OF THE INVENTION

1. Field of the Invention

The present invention relates generally to a truck bed and tailgate extension assembly and, more particularly, to an extension assembly mounted on a truck bed and its lowered tailgate which extension assembly is easily removable from the truck bed and tailgate and then readily stored within the truck bed with the tailgate closed.

2. Description of the Prior Art

Several types of vehicles are used by construction contractors and others desiring to move construction or similar or related materials from the source of the materials, which may be a lumberyard or other source, to the site of the use of the materials, which may be a construction site or a fabrication facility. Most commonly used are pickup trucks, or other trucks of similar or related configuration or construction, which have a flat bed and a tailgate that may be lowered to a horizontal position and restrained in that horizontal position.

Often the materials that must be transported are longer than the flat bed itself, requiring that the tailgate be maintained in a horizontal position so that the extra length can be accommodated. This can lead to several problems, including the lack of restraint of the transported material from movement out the back of the truck and the potential lack of support arising from materials extending beyond the tailgate. Makeshift means to constrain the materials to the truck bed are time-consuming, of limited utility, are typically unsafe, and may violate various vehicular code requirements.

These problems have been addressed in several types of extension devices that have been developed. Most of these devices are cumbersome, large, heavy, expensive, and/or require permanent attachment to the vehicle or significant modification to the vehicle, all to the serious detriment of the user. Further, the design and manufacturing features of prior devices are inefficient for the specific purpose of the present invention, that is, for the carrying of sheets of material which comprise a very significant portion of the materials required for construction and related activities.

Accordingly, there existed, prior to the present invention, a need for an improved truck bed and tailgate extension apparatus to extend beyond the length of the cargo area to allow for the safe, ready and expeditious transport of sheets whose length is greater than the combined length of the bed and the tailgate, when the latter is in the open (horizontal) position. Such an improved apparatus is readily installed on the truck bed and tailgate assembly when required for use and then readily removed from the truck bed and tailgate assembly when not in use. Such an improved apparatus is storable within the truck or truck bed while taking up an insignificant area of the truck or truck bed capacity.

### SUMMARY OF THE INVENTION

The present disclosure of invention is generally directed to a truck bed extension mounted only when needed on the truck bed and lowered (e.g., horizontal) tail gate of a material transport vehicle, such as a pickup truck, providing for enhanced material handling capacity, while being able to be stored within the truck bed when not needed. The invention provides the user with various options of positioning the invention to accommodate varying types and sizes of loads. The present invention is particularly suitable for carrying sheets of material, whether they be sheetrock, plywood, paneling, or any other type of material that is configured in a generally rectangular configuration.

One particular embodiment of the present disclosure provides an apparatus for extending a vehicle cargo area which provides for two rectangular members, each having a first end adapted by way of a series of axially configured through holes to accept an anchoring device, one for each rectangular member, and a second end adapted by a series of axially configured through holes to accept generally vertical rectangular members, one to each of the first aforesaid rectangular members, wherein the anchoring device is comprised of a flat plate of a size greater than the diameter of the holes in the aforesaid first end, which flat plate has attached a pin of diameter slightly smaller than the diameter of said holes such that the pin may be readily inserted through said holes and into the space between the truck bed and the open tailgate, and wherein the generally vertical rectangular member has on its first end a section place at a right angle to said generally vertical member of a size greater than the size of the holes in the second end of the rectangular member and to which section is attached a pin of diameter slightly smaller than the diameter of said holes such that the pins may be readily inserted through said hole while maintaining, in conjunction with the aforesaid section, the integrity of the right angle between the rectangular member and the generally vertical rectangular member when said pin is inserted through said rectangular member.

The embodiment may also contain a second pin on the anchoring device of the same diameter as the first pin, which second pin is on the anchoring devices at a right angle to the first pin, said second pin acting to locate and restrain the rectangular members if said rectangular members are oriented in their alternate configuration, that is, with their cross-sectional height greater than their cross-sectional width. In this alternate configuration, the resistance to bending moment derived from the load is increased.

The embodiment may also contain upon the generally vertical rectangular member one or two additional members and an additional pin of the same diameter as the first pin, which second pin is located on the second end of the generally vertical rectangular member, said pin being perpendicular to the side of said generally vertical member which is wider and wherein the additional members are situated so that serve to stabilize the generally vertical member when said second member is attached by its second end rather than by its first end to the primary rectangular member when the primary rectangular members are oriented in their alternate configuration, that is, with their cross-sectional height greater than their cross-sectional width. As noted above, this alternate configuration, the resistance to bending moment derived from the load is increased. It must be noted that all connecting pins may optionally have holes through them to accommodate a locking device such as a locking pin or wire.

The embodiment may also contain a stabilizer for use when the primary rectangular members are oriented in their alternate configuration described hereinabove, which stabilizer is comprised of a horizontal member placed between the primary vertical member and the tailgate to which horizontal member are attached two vertical members perpendicular to the horizontal member, parallel to each other and separated by a space slightly larger than the small cross-section of the primary horizontal beam.

### BRIEF DESCRIPTION OF THE DRAWINGS

Various embodiments of the presently disclosed apparatus for extending the truck bed and tailgate extension assembly are disclosed herein with reference to drawings wherein:

FIG. 1 is a perspective view of the first embodiment of the truck bed and tailgate extension assembly constructed in accordance with the present disclosure as installed on a truck with a drop-down style tailgate;

FIG. 2 is a perspective view of the second embodiment of the truck bed and tailgate extension assembly constructed in accordance with the present disclosure as installed on a truck with a drop-down style tailgate;

FIG. 3 is an enlarged perspective drawing of the primary rectangular member of said apparatus;

FIG. 4 is an enlarged perspective drawing of the anchoring device of said apparatus with optional second pin; and

FIG. 5 is an enlarged perspective drawing of the rear vertical restraining device of said apparatus with optional second pin and orientation members.

FIG. 6 is an enlarged perspective drawing of the rear stabilizer assembly used for the configuration identified as the second embodiment and as illustrated in FIG. 2.

### DESCRIPTION OF THE PREFERRED EMBODIMENTS

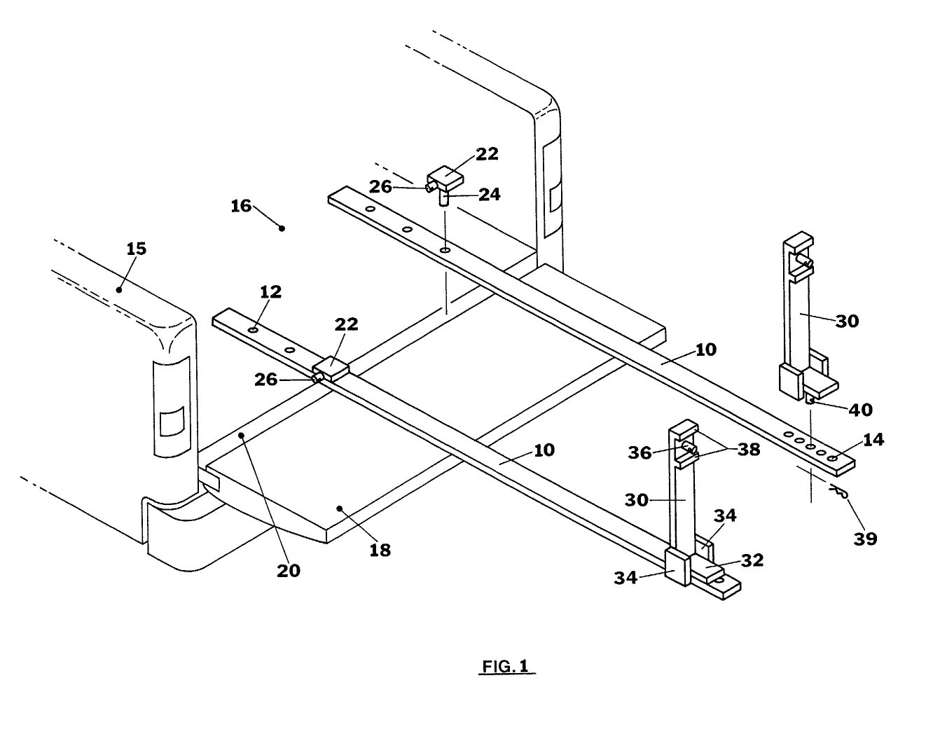

Referring now in specific detail to the drawings, and initially to FIG. 1, one embodiment of a truck bed and tailgate extension assembly constructed in accordance with the present disclosure is shown. The assembly is shown installed on truck bed 16 and tailgate 18 of vehicle 15, which may be a pickup truck or similarly configured vehicle. Horizontal members 10 extend from within the truck bed 16, over the tailgate 18 and past said tailgate 18, thereby extending the effective length of the truck bed 16 and tailgate 18. The extended length thereby created is constrained by generally vertical members 30.

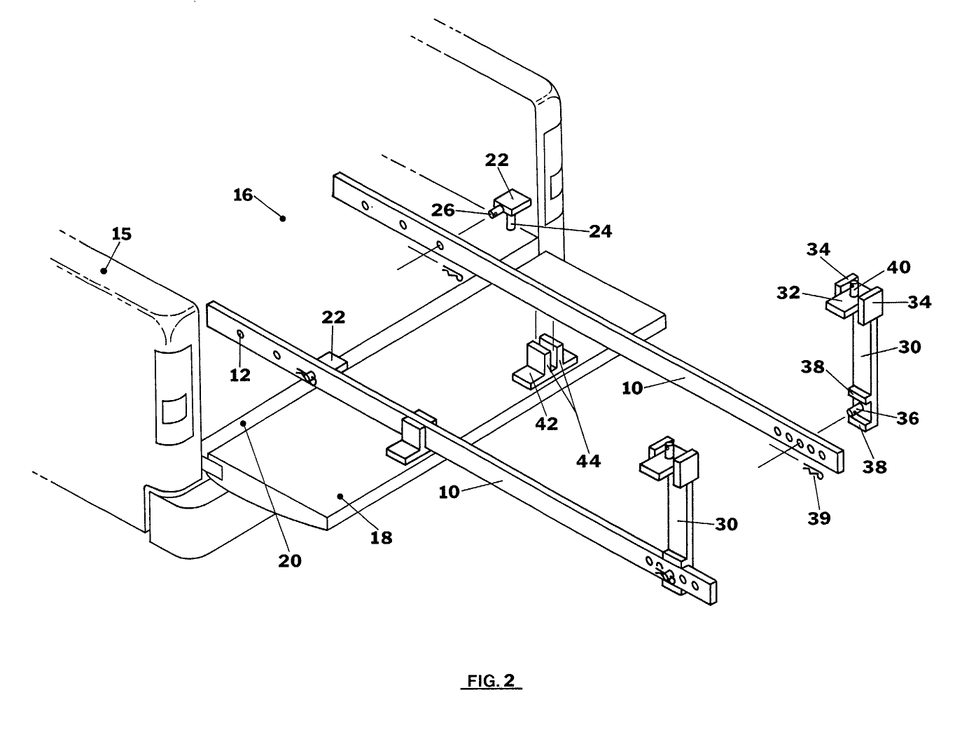

Referring to FIG. 2, a second embodiment of a truck bed and tailgate extension assembly constructed in accordance with the present disclosure is shown. The assembly is shown installed on truck bed 16 and tailgate 18 of vehicle 15, which may be a pickup truck or similarly configured vehicle. Horizontal members 10, now rotated by 90 degrees along their respective axis relative to the first embodiment shown in FIG. 1, extend from within the truck bed 16, over the tailgate 18 and past said tailgate 18, thereby extending the effective length of the truck bed 16 and tailgate 18. The extended length thereby created is constrained by generally vertical members 30.

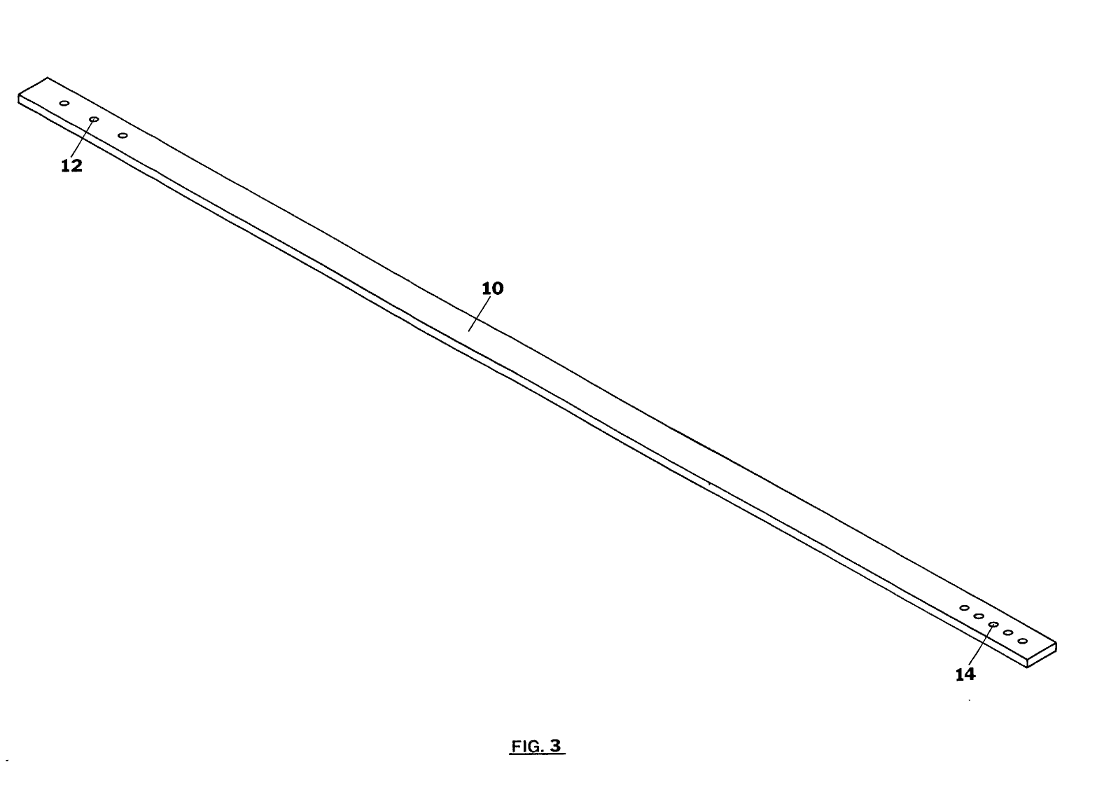

Referring to FIG. 3 and either FIG. 1 or FIG. 2, the rectangular member 10 containing one or more holes 12 on its first end through the member's smaller cross-sectional dimension and a series of holes 14 on its second end through the member's smaller cross-sectional dimension, thereby permitting adjustment of position of rectangular member 10 with respect to the groove 20 between the truck bed 16 and the tailgate 18 and permitting adjustment of the location of restraining device 30.

Referring now to FIG. 3 and either FIG. 1 or FIG. 2, the restraining device 22 is comprised of a plate nominally as wide and deep as the longer cross-sectional dimension of rectangular member 10 to which are affixed by welding or other suitable means one or more pins 24 and 26. In the instance that rectangular member 10 is placed on the vehicle bed 16 and the tailgate 18 as shown in FIG. 1, then pin 24 is used to locate and stabilize the rectangular member 10. Pin 26 is not needed in this configuration. However, in the instance that rectangular member 10 is placed on the vehicle bed 16 and the tailgate 18 as shown in FIG. 2, then pin 26 is used to locate and stabilize the rectangular member 10. Pin 24 is not needed in this configuration.

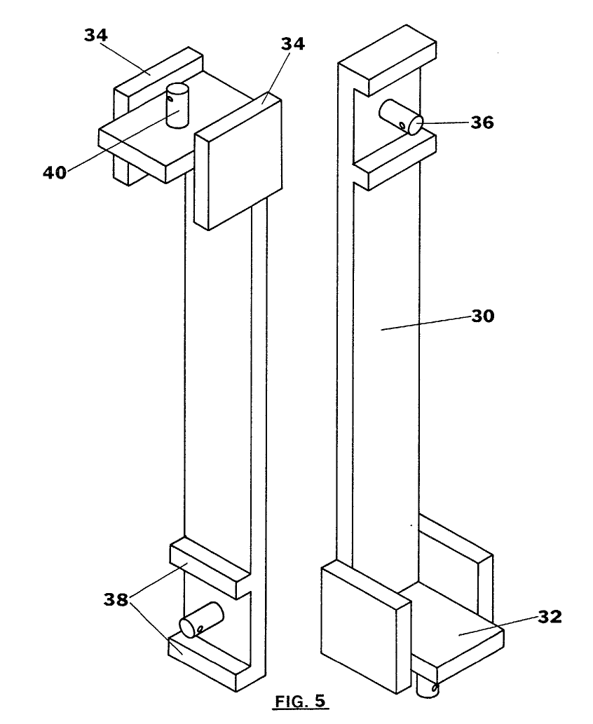

Referring now to FIG. 5, the restraining device 30 has opposite ends required to configure this apparatus in either of the configurations shown in FIG. 1 and FIG. 2. In particular, for the configuration shown in FIG. 1, the assembly comprised of primary member 30, endplate 32, optional reinforcing side-plates 34 and pin 40 are affixed to rectangular member 10 by way of the insertion of pin 40 into the appropriate hole 14 in rectangular member 10. Alternatively, for the configuration shown in FIG. 2, the assembly comprised of primary member 30, two alignment bars 38, and pin 36, said primary member 30 is affixed to rectangular member 10 by way of the insertion of pin 40 into the appropriate hole 14 in rectangular member 10 such that alignment bars 38 are parallel with the long axis of rectangular member 10 and abutting said rectangular member 10 on the top and bottom surfaces thereof, precluding the twisting of primary member 30 around the axis defined by pin 40.

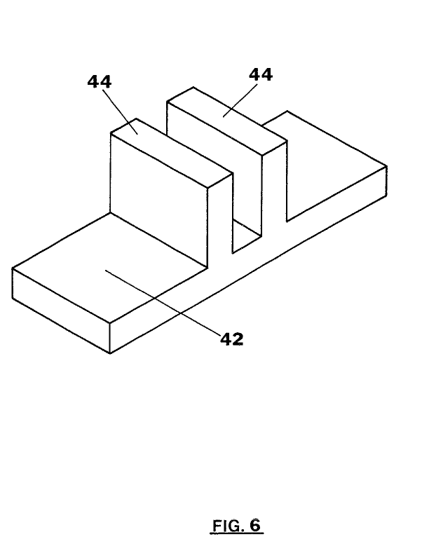

Referring now to FIG. 2 and FIG. 6, the two rear stabilizers comprised of a flat bottom plate 42 to which are attached by welding or other suitable means two vertical plates 44 parallel to each other and with the distance between the plates 44 slightly larger than the smaller cross-sectional dimension of rectangular member 10 such that rectangular member 10 can be inserted between said parallel plates 44 when the rear stabilizer is placed upon truck bed 16 or tailgate 18, the latter embodiment of which is shown in FIG. 2.

Referring again now to FIG. 1 and FIG. 2, it can be seen that the length that the rectangular member 10 extends into the truck bed 16 and extends beyond lowered tailgate 18 can be adjusted by positioning anchoring device 22 on any of the various holes placed in rectangular member 10. Further, the effective length of rectangular member 10 can be varied and set as required by positioning restraining device 30. By way of these adjustments, the apparatus may be adapted for use on varying lengths of truck beds 16 and tail gates 18, as well as being adapted for various sizes of sheet material placed on rectangular member 10 and restrained by restraining device 30.

With further regard to FIG. 1 and FIG. 2, it can be seen that rectangular members 10, anchoring devices 22, positioning restraining devices 30 and rear stabilizers comprised of plates 42 and 44 can easily and conveniently be placed within truck bed 16 with tailgate 18 in the closed, that is, vertical position to permit the convenient storage of the entirety of the assembly within the truck 15.

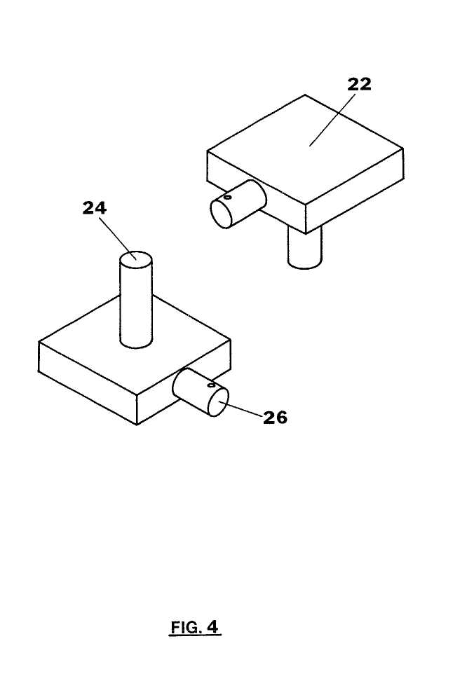

Referring to FIG. 1, FIG. 2, FIG. 4 and FIG. 5, it is seen that pins 26, 36 and 40 may optionally have holes through them to accommodate a locking device such as the locking pin 39.

It will be understood that various modifications can be made to the various embodiments of the presently disclosed apparatus for extending the effective length of vehicle cargo areas, particularly the truck bed and tail gate assemblies, without departing from the spirit and scope of the apparatus. For example, the stock used could be tubular in cross-section and warning devices such as lights could be appended. Therefore, the above delineated description should not be construed as limiting the invention, but rather as presenting the preferred embodiments of the invention. Those skilled in the art will envision other modifications within the scope and spirit of the presently disclosed embodiments of the presently disclosed apparatus for extending the effective length of vehicle cargo areas, particularly the truck bed and tail gate assemblies.

I claim:

1. A truck bed and tailgate extension assembly which comprises:
a pair of primary beams each having a first end adapted for attaching between the bed of a truck and the truck's opened tailgate and a second end adapted for attaching a back beam perpendicular to and rising vertically from said primary beam; and
a pair of back beams, each one attachable to a respective one of the pair of primary beams, perpendicular to said primary beam and rising vertically from said primary beam.

2. A truck bed and tailgate extension assembly as recited in claim 1, where the adaptation for attaching the primary beam between the bed of a truck and the truck's opened tailgate is comprised of a removable locking pin mechanism whose pin protrudes through a hole in its respective primary beam and continues into the gap between the bed of the truck and the truck's opened tailgate.

3. A truck bed and tailgate extension assembly as recited in claim 1, where the adaptation for attaching the primary beam between the bed of a truck and the truck's opened tailgate is comprised of a removable locking pin mechanism whose first pin protrudes through a hole in its respective primary beam and whose second pin, perpendicular to the first pin, extends into the gap between the bed of the truck and the truck's opened tailgate.

4. A truck bed and tailgate extension assembly as recited in claim 2, where the back beams have a first end with a pin located on its side and located between two parallel guide plates.

5. A truck bed and tailgate extension assembly as recited in claim 3, where the back beams have a first end with a pin located on its side and located between two parallel guide plates.

6. A truck bed and tailgate extension assembly as recited in claim 2, where the back beams have a first end with a pin located on a perpendicular extension to the back beam, said pin being perpendicular to the extension and which pin is located between two parallel guide plates located on said extension.

7. A truck bed and tailgate extension assembly as recited in claim 3, where the back beams have a first end with a pin located on a perpendicular extension to the back beam, said pin being perpendicular to the extension and which pin is located between two parallel guide plates located on said extension.

8. A truck bed and tailgate extension assembly as recited in claim 2, where the back beams have a first end with a pin located on its side and located between two parallel guide plates and a second end with a pin located on a perpendicular extension to the back beam, said pin being perpendicular to the extension and which pin is located between two parallel guide plates located on said extension.

9. A truck bed and tailgate extension assembly as recited in claim 3, where the back beams have a first end with a pin located on its side and located between two parallel guide plates and a second end with a pin located on a perpendicular extension to the back beam, said pin being perpendicular to the extension and which pin is located between two parallel guide plates located on said extension.

10. A truck bed and tailgate extension assembly as recited in claim 2, wherein a stabilizer assembly is placed between the primary beam and the truck's tailgate.

11. A truck bed and tailgate extension assembly as recited in claim 8, wherein a stabilizer assembly is placed between the primary beam and the truck's tailgate.

12. A truck bed and tailgate extension assembly as recited in claim 2, wherein a stabilizer assembly is comprised of three segments, one of which is a flat plate and the other two of which are parallel plates attached perpendicularly to said flat plate.

13. A truck bed and tailgate extension assembly as recited in claim 8, wherein a stabilizer assembly is comprised of three segments, one of which is a flat plate and the other two of which are parallel plates attached perpendicularly to said flat plate.

14. A truck bed and tailgate extension assembly as recited in claim 3, where stabilizer assembly is placed between the primary beam and the truck's tailgate.

15. A truck bed and tailgate extension assembly as recited in claim 10, where stabilizer assembly is comprised of three segments, one of which is a flat plate and the other two of which are parallel plates attached perpendicularly to said flat plate.

16. A truck bed and tailgate extension assembly as recited in claim 1, where all of the components can be conveniently stored within the truck bed when the tailgate extension is closed.
